(19) United States
(12) Patent Application Publication
(10) Pub. No.: US 2001/0007722 A1
(43) Pub. Date: Jul. 12, 2001

(54) Magneto-optical recording medium

(75) Inventors: Kouichirou Wakabayashi, Toride-shi (JP); Hiroyuki Awano, Noda-shi (JP)

Correspondence Address: Oliff & Berridge PLC, P.O. Box 19928, Alexandria, VA, 22320, US

(73) Assignee: HITACHI MAXELL, LTD.

(21) Appl. No.: 09/755,103

(22) Filed: Jan. 8, 2001

(30) Foreign Application Priority Data
Jan. 12, 2000 (JP) 2000-003777

(51) Int. Cl. G11B 11/00

(52) U.S. Cl. 428/694 ML

(57) ABSTRACT

A magneto-optical recording medium is provided, which makes it possible to reliably reproduce a long mark by increasing a leak magnetic field from a central portion of a continuous recording mark. The magneto-optical recording medium comprises a magnetic layer which is composed of a soft magnetic material and exhibits in-plane magnetization during reproduction of information, the magnetic layer being disposed in contact with a recording layer between the recording layer and a substrate. The flow of the magnetic flux of the magnetic domain formed in the recording layer is controlled by the magnetic layer, and the magnetic flux from the magnetic domain disposed in the recording layer is in a closed state through the inside of the magnetic layer. Accordingly, a leak magnetic field having a sufficient magnetic field intensity is generated from the central portion of the continuous recording mark. Information stored in the central portion of the continuous recording mark can be reliably transferred to a reproducing layer, and thus the information can be reliably reproduced. The magnetic layer may be also provided on the recording layer.

### BACKGROUND OF THE INVENTION

1. Field of the Invention

The present invention relates to a magneto-optical recording medium on which information is recorded as magnetization information. In particular, the present invention relates to a magneto-optical recording medium for reproducing information by utilizing the leak magnetic field from a recording layer.

2. Description of the Related Art

An information-recording medium such as a magneto-optical recording medium is known as an external memory for a computer or the like. The magneto-optical recording medium is frequently used as a recording medium suitable for the age of multimedia, because it is possible to deal with large capacity data such as those of animation images and voice records. It is demanded for such a magneto-optical recording medium to further increase the storage capacity thereof.

A method for increasing the storage capacity is conceived, in which the recording mark (recording magnetic domain) is allowed to have a minute size so that information is recorded at a high density. In order to realize the minute size of the recording magnetic domain to perform the recording, it is possible to use the light pulse magnetic field modulation system in which a magnetic field having a polarity corresponding to a recording signal is applied while radiating a pulsed light beam in synchronization with a recording clock. According to this system, it is possible to form a minute recording magnetic domain in a recording layer. However, when a plurality of such minute recording magnetic domains exist in a reproducing light beam spot, it is necessary to use a method for distinguishing them to perform reproduction.

In order to distinguish and read a plurality of minute recording magnetic domains existing in the reproducing light beam spot respectively, for example, it is possible to use a technique called “Magnetic Super Resolution (MSR)” suggested in Journal of Magnetics Society of Japan, Vol. 17 Supplement No. S1, pp. 201 (1993). This technique resides in a method in which a magnetic mask, which follows the temperature distribution, is formed in the light spot on a magneto-optical recording medium, and the recording magnetic domain is read from an area called opening (aperture) which is smaller than the light spot. However, in the case of this method, the effective spot radius is decreased by forming the magnetic mask. Therefore, the amount of light, which contributes to the reproduced signal output, is small. For this reason, the amplitude of the reproduced signal is lowered, and it is difficult to obtain sufficient S/N.

As a method for avoiding such a problem, for example, a magneto-optical recording medium has been suggested in Journal of Applied Magnetic Society of Japan, Vol. 21, No. 10, pp. 1187-1192 (1997). The magneto-optical recording medium is provided with a reproducing layer for magnetically transferring, magnifying, and reproducing a minute magnetic domain recorded on a recording layer. In this technique, an external magnetic field, which is synchronized with a recording clock, is alternately applied during reproduction. Thus, each of the minute magnetic domains, which is magnetically transferred to the reproducing layer, is magnified to have a light spot size, followed by being extinguished completely. An amplified signal amplitude is detected from the reproducing layer to read information. This technique is called “MAMMOS” (Magnetic Amplifying Magneto-Optical System), which solves the problem involved in the magnetic super resolution technique described above concerning the decrease in reproduced signal amplitude.

As for the magneto-optical recording medium for MSR and MAMMOS described above, the information recorded on the recording layer is transferred to the reproducing layer by utilizing the leak magnetic field from the recording magnetic domain (recording mark) in the recording layer, and then the information is read from the reproducing layer. However, when a recording mark (continuous mark) having a long mark length is recorded on such a magneto-optical recording medium, and then such a long recording mark is reproduced, then it is difficult to obtain a reproduced signal from a central portion of the mark in some cases. According to the study performed by the present inventors, it has been revealed that such a phenomenon occurs because the leak magnetic field from the central portion of the recording mark is decreased when the recording mark formed in the recording layer is long.

Japanese Patent Application Laid-Open No. 9-198731 discloses a magneto-optical recording medium comprising a recording layer and a reproducing layer, in which an underlayer (lining layer) as a soft magnetic member is provided on a surface of a side of the recording layer on which the reproducing layer is not provided. An object of this technique is to obtain sufficient C/N, for example, when a short mark having a mark length of 0.25 μm is subjected to reproduction. The magneto-optical recording medium has a structure including a non-magnetic layer which is formed between the recording layer and the underlayer. The recording layer and the underlayer are magnetostatically coupled to one another thereby. However, this patent document does not disclose a structure in which an underlayer is provided in contact with a recording layer, and the underlayer and the recording layer are subjected to exchange coupling. Further, this patent document neither teaches nor suggests the problem to be solved by the invention, i.e., the leak magnetic field from the central portion of the recording mark having the long mark length is lowered, and it is impossible to obtain any sufficient reproduced signal intensity from the central portion of the recording mark.

### SUMMARY OF THE INVENTION

The present invention has been made in order to solve the problems involved in the conventional technique as described above, an object of which is to provide a magneto-optical recording medium which makes it possible to reliably reproduce information by generating a leak magnetic field having a sufficient magnetic field intensity even from a central portion of a recording mark having a long mark length.

According to the present invention, there is provided a magneto-optical recording medium comprising:

a substrate;

a recording layer which exhibits perpendicular magnetization;

a reproducing layer to which magnetization information stored in a recording layer is transferred; and

a magnetic layer which is composed of a soft magnetic material to exhibit in-plane magnetization during reproduction of information, wherein:

the magnetic layer is located in contact with the recording layer.

The magneto-optical recording medium according to the present invention comprises, in contact with the recording layer, the magnetic layer which is composed of the soft magnetic material to exhibit the in-plane magnetization during the reproduction of information. The phrase “soft magnetic material to exhibit in-plane magnetization during reproduction of information” means a soft magnetic material having the magnetization-prompt axis in the in-plane direction at a temperature (reproducing temperature) to which the magneto-optical recording medium is heated by being irradiated with a reproducing light beam during the reproduction of information. The reproducing temperature is usually about 100° C. to 300° C. Such a magnetic layer is formed between the substrate and the recording layer or on the recording layer, and it functions as a magnetic layer for controlling the flow of the magnetic flux generated from the magnetic domain formed in the recording layer. Therefore, in the following description, the magnetic layer described above is conveniently referred to as “magnetic flux control layer”. The magnetic flux control layer makes exchange coupling to the recording layer, because it is formed in contact with the recording layer.

When the magneto-optical recording medium is of the type in which the information stored in the recording layer is read by allowing the light beam to come thereinto from the side of the substrate, it is preferable that the magnetic flux control layer is provided on the recording layer. In the case of a magneto-optical recording medium of the type in which the information stored in the recording layer is read from the side opposite to the substrate, for example, a magneto-optical recording medium of the type in which the leak magnetic field from the recording layer is directly detected without a reproducing layer, or a magneto-optical recording medium of the type in which the information is read by allowing the light beam to come thereinto from the side opposite to the substrate, it is preferable that the magnetic flux control layer is provided between the substrate and the recording layer. The magneto-optical recording medium according to the present invention is provided with the magnetic flux control layer as described above. Accordingly, it is possible to increase the leak magnetic field from the central portion of the recording mark having the long mark length. It is possible to reliably perform the reproduction from the recording mark having the long mark length. The reason thereof will be explained below.

As shown in a lower part of FIG. 3A, when recording marks each having a long mark length are formed (recorded) in a recording layer of a conventional magneto-optical recording medium provided with only a recording layer and the recording layer is scanned with a magnetic head, a reproduced signal as shown in a graph in an upper part of FIG. 3A is detected. As understood from the graph, the obtained reproduced signal is large at a boundary portion between the upward magnetic domain (recording mark) and the downward magnetic domain (erasing mark). However, the reproduced signal from a central portion of the upward magnetic domain or the downward magnetic domain is considerably small, probably because of the following reason. That is, the large leak magnetic field is generated only at the boundary portion between the upward magnetic domain and the downward magnetic domain. The leak magnetic field is scarcely generated from the central portion of each of the magnetic domains. For this reason, for example, in the case of the magneto-optical recording medium of the type in which the magnetic domain in the recording layer is magnetically transferred to the reproducing layer by the aid of the leak magnetic field thereof, and the information transferred to the reproducing layer is read, it is difficult to transfer the magnetization of the central portion of the recording mark having the long mark length to the reproducing layer. Therefore, as described in the section of the related art, the following problem arises. That is, when the central portion of the recording mark having the long mark length is subjected to the reproduction, it is difficult to obtain the reproduced signal from the central portion.

On the contrary, in the case of the magneto-optical recording medium according to the present invention, as shown in FIG. 3B, the magnetic flux of the central portion of the downward magnetic domain is directed toward the central portion of the upward magnetic domain by the aid of the magnetic flux control layer, owing to the presence of the magnetic layer (magnetic flux control layer) having the in-plane magnetization. That is, the magnetic flux is in the closed state in the direction from the downward magnetic domain to the upward magnetic domain in the recording layer, in the magnetic layer which is disposed at the lower surface of the recording layer. When the state, in which the magnetic flux is closed, is formed on the first side (lower surface) of the recording layer as described above, the leak magnetic field having the strong magnetic field intensity is generated from the central portion of the upward magnetic domain to the central portion of the downward magnetic domain on the second side (upper surface) of the recording layer. Therefore, even in the case of the recording mark having the long mark length, it is possible to obtain the sufficiently large leak magnetic field from the central portion thereof. For example, when the reproducing layer is provided just over the recording layer, it is possible to allow the leak magnetic field having the sufficient magnetic field intensity to arrive at the reproducing layer. It is possible to reliably transfer the magnetization information stored in the recording layer to the reproducing layer. Therefore, even in the case of the recording mark having the long mark length, it is possible to reproduce the information stored in the central portion thereof. In the foregoing explanation, the reason why the leak magnetic field from the central portion of the recording mark having the long mark length is increased has been described as exemplified by the case in which the magnetic layer is provided between the substrate and the recording layer. However, another arrangement, in which the magnetic layer is provided on the surface of the recording layer on the side opposite to the substrate, also follows the same principle.

In the magneto-optical recording medium according to the present invention, if the magnetization in the in-plane direction of the magnetic layer exists when the information is recorded, it is feared that the formation of the recording magnetic domain in the recording layer is obstructed. Therefore, it is desirable for the magnetic layer that the magnetization disappears upon the recording of information. As shown in FIG. 4, in order to satisfy the condition as described above, it is preferable that the Curie temperature Ta of the magnetic layer is lower than the Curie temperature Tr of the recording layer. Usually, the Curie temperature of the recording layer is about 200° C. to 300° C. Therefore, it is preferable to adjust, for example, the composition and the material for constructing the magnetic layer so that the Curie temperature is lower than the temperature described above. Some materials for constructing the magnetic layer are such materials that the compensation temperature does not exist between the room temperature and the Curie temperature. Therefore, FIG. 4 shows, by way of example, two type of curves, i.e., a curve in which the magnetization is monotonously decreased from the low temperature to the Curie temperature (curve depicted with a dotted line), and a curve in which the magnetization is once zero between the low temperature and the Curie temperature (curve depicted with a solid line).

In the present invention, it is preferable that the film thickness of the magnetic layer is 1 nm to 100 nm. For example, when a ferromagnetic material such as Co and Fe having large saturation magnetization (Ms) is used for the magnetic layer, a significant effect is obtained provided that the film thickness of the magnetic layer is not less than 1 nm. For example, when a material such as GdFe alloy and GdCo alloy having small saturation magnetization (Ms) is used for the magnetic layer, it is necessary that the film thickness is thickened as compared with the material having large Ms such as the ferromagnetic material described above. In this case, it is preferable that the film thickness is about 50 nm to 100 nm. It is also possible that the film thickness of the magnetic layer is thicker than 100 nm. However, it is feared that the recording or the reproduction of information cannot be performed in a reliable manner unless the power of the radiating laser beam is increased upon the recording or the reproduction of information. Therefore, it is preferable that the upper limit value of the film thickness of the magnetic layer is about 100 nm.

In the present invention, the magnetic layer may be constructed by using a soft magnetic material such as permalloy, Gd-based alloy, rare earth metal-transition metal alloy. For example, when the magnetic layer is composed of the rare earth metal-transition metal alloy, for example, then the transition metal is preferably at least one of Fe and Co, and the rare earth metal is preferably at least one selected from the group consisting of Gd, Er, Tm, Nd, Pr, Sm, Ce, La, and Y. Especially, in order that the magnetization of the magnetic layer does not make any harmful influence during the recording of information, it is preferable that the magnetic layer is constructed by using the material having the Curie temperature which is lower than the Curie temperature of the recording layer. For example, such a soft magnetic material is preferably GdFe, GdCo, or GdFeCo alloy. Alternatively, the magnetic layer may be also constructed by using alloy principally containing Co—Zr. Especially, it is preferable to use amorphous alloy containing, in the alloy described above, at least one element selected from Ta, Nb, and Ti. Further alternatively, the magnetic layer may be formed by using a magnetic material having the nano-crystal structure obtained by uniformly dispersing and depositing a nitride or a carbide of at least one element selected from Ta, Nb, and Zr.

The reproducing layer of the magneto-optical recording medium of the present invention may be, for example, a magnetic domain-magnifying reproducing layer to be used for a magneto-optical recording medium for MAMMOS as disclosed by the present applicant in WO98/02878, and a reproducing layer to be used for a magneto-optical recording medium reproduced based on the magnetic super resolution.

The recording layer to be used for the magneto-optical recording medium according to the present invention is a magnetic layer having perpendicular magnetization for recording information. For example, it is possible to use a multilayered film composed of platinum group metal-transition metal such as Pt—Co, Pt—Fe, and Pd—Co, or rare earth metal-transition metal alloy such as TbFeCo, GdFeCo, TbDyFeCo, DyFeCo, GdTbFeCo, and GdDyFeCo. Further, the material for constructing the recording layer is not limited thereto. For example, it is possible to use arbitrary magnetic materials provided that the material is a material for a recording layer to be used, for example, for a magneto-optical recording medium for the reproduction based on the magnetic super resolution, a magneto-optical recording medium for the production based on the magnetic domain magnification, and a magneto-optical recording medium for the light modulation overwrite.

In the present invention, the recording layer may be constructed with a recording holding layer for holding information, and a recording auxiliary layer (capping layer) formed of a soft magnetic material to exhibit perpendicular magnetization. The magnetic material as described above may be used as it is for the recording holding layer. The recording auxiliary layer is composed of a soft magnetic material in which the magnetization direction is easily oriented in the direction of the external magnetic field, for which it is preferable to use, for example, a soft magnetic material such as permalloy and Gd-based alloy. When the recording magnetic field is applied in order to record information on the recording layer constructed by the recording holding layer and the recording auxiliary layer as described above, the magnetization of the recording auxiliary layer is oriented in the direction of application of the recording magnetic field prior to the magnetization of the recording holding layer. Accordingly, the magnetization of the recording holding layer can be easily oriented in the direction of the recording magnetic field by the aid of not only the recording magnetic field but also the exchange coupling force between the recording holding layer and the recording auxiliary layer in which the magnetization has been oriented. Therefore, it is possible to improve the recording sensitivity of the medium. During reproduction of the information and during a period until the information is rewrote, the recording auxiliary layer maintains the orientation of the magnetization in the same direction as that of the magnetization of the recording holding layer in accordance with the exchange coupling force.

### BRIEF DESCRIPTION OF THE DRAWINGS

FIG. 1 shows a schematic sectional view illustrating a magneto-optical recording medium for MAMMOS as a specified embodiment of the magneto-optical recording medium according to the present invention.

FIG. 2 shows a schematic sectional view illustrating a magneto-optical recording medium for the reproduction based on the magnetic super resolution of the CAD type as a specified embodiment of the magneto-optical recording medium according to the present invention.

FIG. 3A shows reproduced signals obtained when long marks formed in the recording layer are scanned with a magnetic head, illustrating a situation obtained when only the recording layer is used.

FIG. 3B shows reproduced signals obtained when long marks formed in the recording layer are scanned with a magnetic head, illustrating a situation obtained when the magnetic layer is formed.

FIG. 4 shows a graph illustrating the temperature dependency of the magnetization of the recording layer and the magnetic layer of the magneto-optical recording medium according to the present invention, in order to explain the fact that the Curie temperature of the magnetic layer is lower than the Curie temperature of the recording layer.

### DESCRIPTION OF THE PREFERRED EMBODIMENTS

Embodiments of the magneto-optical recording medium according to the present invention will be specifically explained below with reference to the drawings.

### First Embodiment

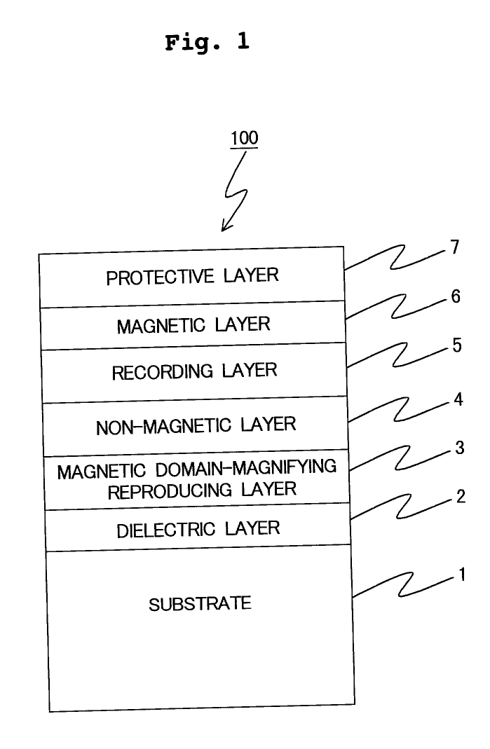

In this embodiment, a magneto-optical recording medium for MAMMOS was produced as a specified embodiment of the magneto-optical recording medium according to the present invention. FIG. 1 shows a cross-sectional structure of the magneto-optical recording medium for MAMMOS. The magneto-optical recording medium 100 has a structure in which a dielectric layer 2, a magnetic domain-magnifying reproducing layer 3, a non-magnetic layer 4, a recording layer 5, a magnetic layer (magnetic flux control layer) 6, and a protective layer 7 are successively stacked on a transparent substrate 1.

In the structure shown in FIG. 1, the transparent substrate 1 is a polycarbonate substrate manufactured with an unillustrated injection molding machine, and it has irregularities corresponding to a preformat pattern on its surface with a thickness of 1.2 mm. The dielectric layer 2 is a layer for allowing the reproducing light beam to cause multiple interference in the layer in order that the detected Kerr rotation angle is substantially increased. The dielectric layer 2 is constructed of silicon nitride. The magnetic domain-magnifying reproducing layer 3 is a layer which makes it possible to magnify and reproduce the magnetic domain transferred from the recording layer 6. The magnetic domain-magnifying reproducing layer 3 is constructed of a perpendicularly magnetizable film of GdFeCo which exhibits ferri-magnetization. The nonmagnetic layer 4 is a layer to effect the magnetostatic coupling by breaking the exchange coupling force between the reproducing layer 3 and the recording layer 5. The non-magnetic layer 4 is constructed of silicon nitride. The recording layer 5 is a layer in which information is recorded as magnetization information. The recording layer 5 is constructed of a rare earth metal-transition metal amorphous film of TbFeCo which has perpendicular magnetization. The magnetic layer 6 is constructed of GdFeCo. The protective layer 7 is a layer to protect the respective layers 2 to 6 which are stacked on the substrate 1. The protective layer 7 is constructed of silicon nitride. The layers 2 to 7 were successively formed into films under the following condition by using an unillustrated sputtering apparatus.

When the film of the dielectric layer 2 was formed, Si was used as a target material, and the sputtering was performed in a mixed atmosphere of Ar and N₂. The film thickness of the dielectric layer 2 was 20 nm. When the film of the magnetic domain-magnifying reproducing layer 3 was formed, Gd, Fe, and Co were co-sputtered using the respective substance targets. In the co-sputtering, the film composition was adjusted by controlling the ratio of input electric power to the respective targets. The film composition of the magnetic domain-magnifying reproducing layer 3 was adjusted so that the compensation temperature and the Curie temperature were about 80° C. and about 270° C. respectively. The film thickness was 20 nm.

When the film of the non-magnetic layer 4 was formed, Si was used as a target material. The sputtering was performed in an atmosphere of Ar+N₂. The film thickness was 20 nm. When the film of the recording layer 5 was formed, Tb, Fe, and Co were co-sputtered using the respective substance targets. The film composition of the recording layer was adjusted so that the compensation temperature was about 25° C. and the Curie temperature was 310° C. The film thickness of the recording layer 5 was 50 nm. When the film of the magnetic layer 6 was formed, GdFeCo was formed to directly make exchange coupling to the recording layer 5. The film thickness of the magnetic layer 6 was 50 nm. When the film of the protective layer 7 was formed, Si was used as a target material, and the sputtering was performed in an atmosphere of Ar+N₂. The film thickness was 20 nm. Thus, the magneto-optical recording medium 100 having the stacked structure shown in FIG. 1 was manufactured.

Subsequently, a recording mark having a mark length of 1.6 μm was formed in the recording layer of the obtained magneto-optical recording medium by using an unillustrated recording and reproducing apparatus to detect a reproduced signal from the recording mark. The decrease of the reproduced signal was not observed at any lengthwise position of the recording mark. In particular, a reproduced signal having a satisfactory signal intensity was also detected from a central portion of the recording mark.

### Second Embodiment

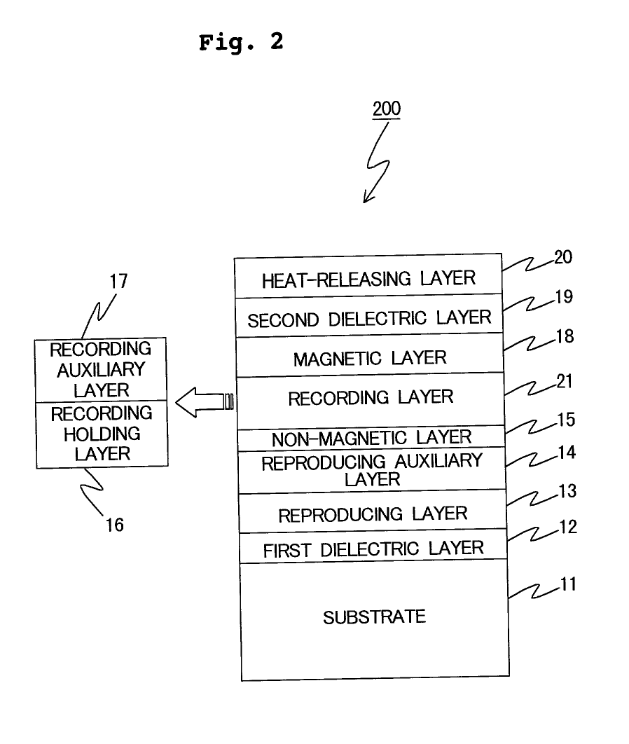

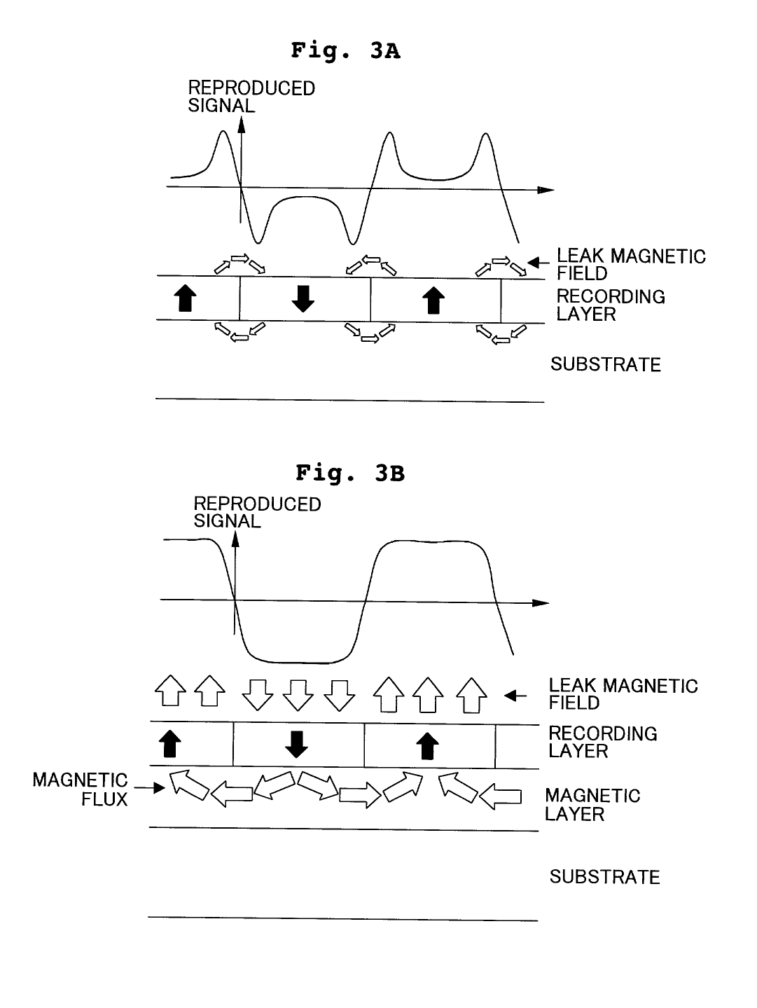

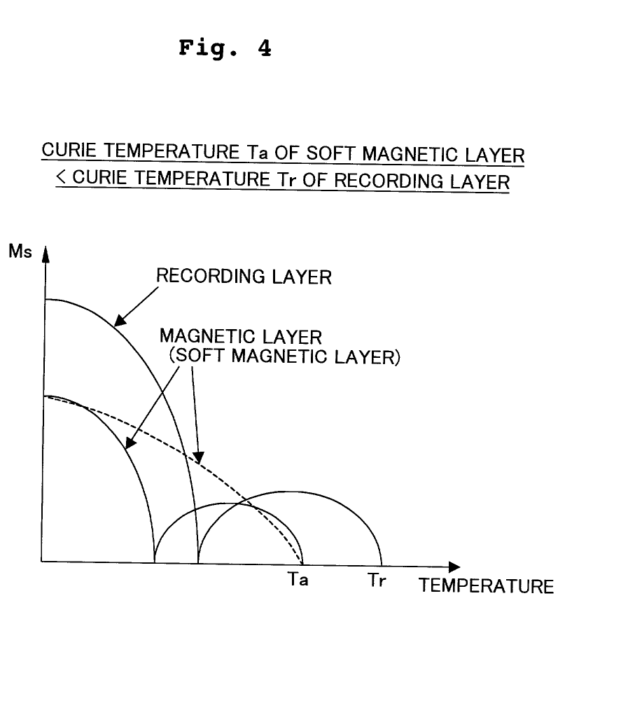

In this embodiment, a magneto-optical recording medium for the magnetic super resolution of the CAD type having a recording layer constructed by a recording holding layer and a recording auxiliary layer (capping layer) was manufactured as another specified embodiment of the magneto-optical recording medium according to the present invention. FIG. 2 schematically shows a cross-sectional structure of such a magneto-optical recording medium. The magneto-optical recording medium 200 has a structure in which a first dielectric layer 12, a reproducing layer 13, a reproducing auxiliary layer (mask layer) 14, a nonmagnetic layer 15, a recording layer 21, a magnetic layer (magnetic flux control layer) 18, a second dielectric layer 19, and a heat-releasing layer 20 are successively stacked on a transparent substrate 11. The recording layer 21 includes a recording holding layer 16 and a recording auxiliary layer (capping layer) 17 as shown on the left side of the plane of paper of FIG. 2.

In the structure shown in FIG. 2, the transparent substrate 11 is a polycarbonate substrate manufactured by using an unillustrated injection molding machine in the same manner as in the first embodiment, and it has irregularities corresponding to a preformat pattern on its surface with a thickness of 1.2 mm. The first dielectric layer 12 is a layer for allowing the reproducing light beam to cause multiple interference in the layer in order that the detected Kerr rotation angle is substantially enhanced. The first dielectric layer 12 is constructed of silicon nitride.

The reproducing layer 13 is a layer to which information stored in the recording layer 21 is transferred during the reproduction of the information. The reproducing layer 13 is constructed of a rare earth metal-transition metal amorphous film of GdFeCo which is an in-plane magnetizable film at room temperature. The reproducing auxiliary layer 14 is a layer which functions as a mask layer during the reproduction of information. The reproducing auxiliary layer 14 is constructed of a rare earth metal-transition metal amorphous film of GdFe which exhibits in-plane magnetization at room temperature. The non-magnetic layer 15 is a layer to effect the magnetostatic coupling by breaking the exchange coupling force between the reproducing layer 13 and the recording layer 21. The non-magnetic layer 15 is constructed by using silicon nitride. The recording holding layer 16, which constitutes the recording layer 21, is a layer in which information is recorded as magnetization information. The recording holding layer 16 is constructed of a rare earth metal-transition metal amorphous film of TbFeCo which has perpendicular magnetization. The recording auxiliary layer 17 is constructed of a rare earth metal-transition metal amorphous film of GdFeCo which exhibits in-plane magnetization at room temperature. The magnetic layer 18 is constructed of GdFeCo which exhibits in-plane magnetization during the reproduction. Both of the second dielectric layer 19 and the heat-releasing layer 20 are layers to control the heat distribution caused by the laser beam. The second dielectric layer 19 and the heat-releasing layer 20 are constructed of silicon nitride and AlTi respectively. The layers 12 to 20 were successively formed into films as follows by using an unillustrated sputtering apparatus.

When the film of the dielectric layer 12 was formed, silicon nitride was used as a target material, and the film thickness was 60 nm. When the film of the reproducing layer 13 was formed, a Gd target and an FeCo alloy target were co-sputtered. In the co-sputtering, the ratio of the input electric power to the respective targets was controlled to adjust the film composition so that both of the compensation temperature and the Curie temperature of the reproducing layer 13 were not less than 300° C., and the critical temperature for the transition of the magnetization-prompt direction from the in-plane direction to the perpendicular direction was about 140° C. to 200° C. The film thickness of the reproducing layer 13 was 20 nm to 40 nm.

When the film of the reproducing auxiliary layer 14 was formed, a Gd target and an Fe target were co-sputtered to make adjustment so that the Curie temperature of the reproducing auxiliary layer 14 was 150° C. to 200° C. The film thickness of the reproducing auxiliary layer 14 was 5 nm to 20 nm. When the film of the non-magnetic layer 15 was formed, silicon nitride was used as a target material, and the film thickness was 5 nm. When the film of the recording holding layer 16 was formed, a Tb substance target and an FeCo alloy target were co-sputtered to adjust the film composition so that the compensation temperature of the recording holding layer was about 0° C. to 80° C., and the Curie temperature was 200° C. to 250° C. The film thickness of the recording holding layer 16 was 30 nm to 60 nm.

When the film of the recording auxiliary layer 17 was formed, a Gd target and an FeCo alloy target were co-sputtered to obtain a magnetic layer composed of GdFeCo having a film thickness of 3 nm to 15 nm and a Curie temperature of 200° C. to 350° C. When the film of the magnetic layer 18 was formed, a Gd target and an FeCo alloy target were co-sputtered to form a layer composed of GdFeCo. The film composition was adjusted so that the compensation temperature was not less than 280° C. and the Curie temperature was within a range of 250° C. to 280° C. The film thickness of the magnetic layer 18 was 100 nm which was thicker than that of the medium described in the first embodiment, because of the following reason. That is, it is necessary to confine the magnetic flux from the recording auxiliary layer 17 in the magnetic layer 18, because the saturation magnetization is large and the amount of magnetic flux is large in the recording auxiliary layer 17. When the film of the second dielectric layer 19 was formed, silicon nitride was used as a target material, and the film thickness was 10 nm to 30 nm. When the film of the heat-releasing layer 20 was formed, Al₉₇Ti₃ was used as a target material, and the film thickness was 20 to 50 nm. Thus, the magneto-optical recording medium having the stacked structure as shown in FIG. 2 was manufactured.

Subsequently, a recording mark having a mark length of 3.2 μm was formed in the recording layer of the manufactured magneto-optical recording medium, and then the recording mark was subjected to reproduction to measure C/N. As a result, a satisfactory waveform was observed at any lengthwise position of the recording mark, and high C/N was successfully obtained. That is, the reproduction was successfully performed in a reliable manner even in the case of the recording mark having the long mark length. Further, information was successfully recorded in a reliable manner on the magneto-optical recording medium according to the embodiment of the present invention, even when the magnetic field intensity was low during the recording of information, probably because of the following reason. That is, the recording sensitivity was improved owing to the provision of the recording auxiliary layer made of the soft magnetic material to exhibit the perpendicular magnetization.

The magneto-optical recording medium according to the present invention includes the magnetic layer which exhibits the in-plane magnetization during the reproduction of information, the magnetic layer being provided to make contact on the side of the first surface of the recording layer. Accordingly, the magnetic flux is closed by the aid of the magnetic layer on the side of the first surface of the recording layer, and the leak magnetic field from the second side of the recording layer is remarkably increased. Therefore, even in the case of the recording mark having the long mark length, the leak magnetic field, which has the magnetic field intensity sufficient to make transfer to the reproducing layer, is generated from the central portion thereof. Thus, it is possible to reliably reproduce information.

What is claimed is:

1. A magneto-optical recording medium comprising:
a substrate;
a recording layer which exhibits perpendicular magnetization;
a reproducing layer to which magnetization information stored in a recording layer is transferred; and
a magnetic layer which is composed of a soft magnetic material and exhibits in-plane magnetization when the information is reproduced, wherein:
the magnetic layer is located in contact with the recording layer.

2. The magneto-optical recording medium according to claim 1, wherein the recording layer is located between the magnetic layer and the reproducing layer.

3. The magneto-optical recording medium according to claim 2, wherein the reproducing layer is a magnetic domain-magnifying reproducing layer to which a magnetic domain is transferred from the recording layer and in which the transferred magnetic domain is magnified.

4. The magneto-optical recording medium according to claim 1, wherein a Curie temperature of the soft magnetic material is lower than a Curie temperature of a magnetic material of the recording layer.

5. The magneto-optical recording medium according to claim 1, wherein a Curie temperature of the soft magnetic material is within a range of 100° C. to 350° C.

6. The magneto-optical recording medium according to claim 1, wherein a film thickness of the magnetic layer is within a range of 50 nm to 100 nm.

7. The magneto-optical recording medium according to claim 1, wherein the recording layer is formed by a recording holding layer which holds recording information, and a recording auxiliary layer which is composed of a soft magnetic material and exhibits perpendicular magnetization.

8. The magneto-optical recording medium according to claim 1, wherein the soft magnetic material is composed of one of magnetic materials selected from the group consisting of permalloy, GdFe, GdCo, GdFeCo and ErFeCo.
